(19) United States
(12) Patent Application Publication
(10) Pub. No.: US 2016/0298594 A1
(43) Pub. Date: Oct. 13, 2016

(54) MECHANICAL LEVERAGE AND GRAVITY GENERATING CLEAN POWER PLANT

(71) Applicant: ARVIND A DAYA, FAYETEVILLE, GA (US)

(72) Inventor: ARVIND A DAYA, FAYETEVILLE, GA (US)

(21) Appl. No.: 14/680,188

(22) Filed: Apr. 7, 2015

(51) Int. Cl. F03B 13/06; H02K 7/18; F03B 7/00

(52) U.S. Cl. CPC F03B 13/06; F03B 7/003; F03B 7/006; H02K 7/1807; Y10S 415/916; F03B 17/005

(57) ABSTRACT

The present invention provides a system generating electricity by plurality of the long mechanical leverage arms reciprocating on one way clutches whereby turning input shaft of the primary transmission thus turning generator additionally thereby applying gravity force. This system includes a plurality of conveyer cylinder tanks mounted on a circulating device. When the tanks receive the working medium with aid of a pump descending from a higher place by gravity, the circulating device is driven to circulate along a guiding device so as to reciprocate the said first end of long mechanical leverage arms for generating electricity, a secondary transmission is added between the circulating device and the motor maintaining the specified generator rotational speed furthermore the secondary transmission is fitted with a disc type flywheel with caliper to stop the flywheel, the device operates with 20% of its energy, it produces.

The present invention relates to a system for generating electricity, and more particularly to a system for generating electricity by gravity and long mechanical leverage arms.

### BACKGROUND OF THE INVENTION

Conventional methods for generating electricity include hydro power, fossil fuel, nuclear power, solar power, wind power and gravity systems which utilize water which is re-circulated to operate a water wheel type driven electrical generator.

Hydro power or wind power available in many locations, solar is inconsistent and these locations generally must rely on fossil fuel or nuclear plants which generate pollution of one form or another. This causes serious harm globally.

### SUMMARY OF THE INVENTION

An objective of the present invention is to provide a system substituting for the hydropower and a controlled mechanical leveraging system for generating electricity whereby frequency is precisely controlled for various applications and economically.

Another objective of the present invention is to provide a system for generating considerable electricity.

Another objective of the present invention is to provide a system for generating electricity that can be installed any part of the globe.

A further objective of the present invention is to provide a system for generating electricity without polluting the environment in any form.

In accordance with the present invention, a system for generating electricity includes a system body, a vertical conveyer circulating device with a plurality of spaced cylinder type tanks, a guiding device for the reciprocating long mechanical leverage arms and the same said guiding device is for said vertical conveyer circulating device, a primary transmission, a secondary transmission, a fluid storage first lower tank, a water pump and a generator.

In accordance with another aspect of the present invention, an example of said invention is explained to get a better picture and understanding with a Generator size of 60 Kw 1500 rpm, 50 hz, a water pump in this example will be 10 hp, 5.9 to 7 Kw pumping 500 gal per min at 50 ft head height of vertical conveyer system, a motor 2 hp 2.76 Kw 3000 rpm regulating and maintain 1500 rpm at the said generator end, along with a conveyer system for conveying cylinder tanks circulated, furthermore four long mechanical leverage arms of a 100 ft length and two sets of transmissions, first said primary transmission 1500:1 ratio and the second said secondary transmission 7.5:1 ratio. The said device function on its own power consuming 20% of the energy it produces. To get the said device started it needs the said 20% power from external source approx. 10 Kw.of power to get the said 2 hp motor started and 10 hp motor to start pumping working material in to the conveyer cylinder tank, upon the generator reaching 1500 rpm the said device operates on its own power, thus external source is disconnected.

In accordance with another aspect of the present invention, the system for generating electricity further includes a plurality of minimum of four spaced parallel long mechanical leverage arms, working in pairs to balance the arms weight thus momentum stabilizing the device that further stabilizes momentum inertia of the working shaft, the first end of each of the long mechanical leverage arm is attached to the said vertical conveyer circulating device and the second end of each said long mechanical leverage arm is fixed to a one way clutch assembly. Each of the arms operates systematically.

In accordance with another aspect of the present invention, as each of the long mechanical leverage arm reciprocates causing the said primary transmission (as in this example ratio 1500:1) input shaft to rotate in one direction with aid of the said one way clutches on the said long mechanical leverage arms reciprocating whereby causing the said generator to rotate.

In accordance with another aspect of the present invention, the system for generating electricity further includes a second upper tank for supplying the working medium to the first top said conveyer mounted cylinder tank, or through a large delivery pipe from a said first lower storage tank wherein collecting the working medium obtained from the second said conveyer cylinder tank. A device for pumping the working medium from the said first lower tank to the said second upper tank, or said delivery pipe to each of the circulating said conveyer mounted cylinder tanks as they circulates pass the said delivery pipe, as in this example 500 gpm.

In accordance with another aspect of the present invention, the secondary transmission is mounted on the system body and driven by the electrical motor to rotate the circulating device and maintain a specified speed of the reciprocation motion of the long mechanical leverage arms, whereby alternatively applying the gravity force and maintain generator specified rpm, furthermore the secondary transmission has a disc type flywheel for momentum stabilizing and a caliper type of braking system mounted on the said disc type flywheel to stop the device.

In accordance with another aspect of the present invention, the primary transmission includes a gearbox mounted to the generator body and driven to rotate the generator to the required rpm, furthermore a flywheel is attached as a momentum stabilizing device on the said primary transmission.

In accordance with another aspect of the present invention, the circulating device further includes a plurality of parallelly spaced long mechanical leverage arms where the first end of the said long mechanical leverage arms is connected to the circulating device on a common rotating shaft and sprocket gears, and second end of the long mechanical leverage arms are connected to the one way clutch assembly on the primary input transmission shaft.

In accordance with another aspect of the present invention, the circulating device further includes a plurality of parallelly spaced ladder shafts circulatably mounted on the system body along with the said conveyer mounted cylinder tanks, a plurality of connecting pieces respectively connecting together the ladder shafts along with horizontally mounted said conveyer mounted cylinder tanks, and a plurality of fixing pieces [respectively] fixed to the ladder shafts for respectively fixing thereto the second said conveyer mounted cylinder tanks on common rotating shafts and gears.

In according with another aspect of the present invention, all said conveyer mounted cylinder tanks has a top inlet opening when faced up and when faced down the said opening outlet dumping working fluid into said first lower storage tank, whereby the face up and face down is controlled by said rotary conveyer ladder.

In accordance with another aspect of the present invention, the said first lower storage tank can be used as a swimming pool where a common pump is used to clean the said pool water and deliver the water to the top, 50 ft of said storage tank or directly into each of the appropriate said conveyer mounted cylinder tank of the device systematically as they pass the filler pipe.

In accordance with another aspect of the present invention, as in this example the total combine weight of the water in the conveyer cylinders pumped per minute (500 gal=4170 lbs., power 230V/460V−25.8A/2.9A=5.9 Kw) is respectively filled in the said conveyer mounted cylinder tanks maintains accurate required total weight of 4170 lbs as they circulate accumulatively applying constant gravity force systematically to each of the long mechanical leverage arms overcoming torque turning of the said generator specification rpm, (as in this example: 60 Kw, 1500 rpm=281.50 lbft torque×1500 ratio=422,226.8 lbft divided by 100 ft long mechanical leverage arm=4222 lbs. of force required to overcome the torque at the said generator.)

In accordance with another aspect of the present invention, an electrical motor (as in this example: a 2 hp, 3000 rpm, 2.76 Kw) is attached to turn the circulating said conveyer cylinders tanks and reciprocates long mechanical leverage arms accurately through a medium of a secondary transmission. The primary responsibility of the said electrical motor is to maintain required frequency of the said generator. Larger unit could be built.

The present invention may best be understood through the following description with reference to the accompanying drawings, in which:

### BRIEF DESCRIPTION OF DRAWINGS

FIG. 1 is a perspective view showing a preferred embodiment for generating electricity by gravity according to the present invention.

FIG. 2 depicts a side view of long mechanical leverage arm reciprocating alternatively with the aid of conveyer cylinder tanks filled with working material whereby applying gravity force continuously.

FIG. 3 depicts a front view of dual sets of cylinder conveyer on each end and pumps along with centered long mechanical leverage arms conveyer all on a common shafts.

FIG. 4 depicts working medium filled cylinder applying gravity force as the cylinder conveyer circulates.

FIG. 5 depicts discharging working medium as cylinder conveyer circulates.

FIG. 6 depicts a farm of preferred embodiments for generating electricity by gravity to feed the grid.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only; it is not intended to be exhaustive or to be limited to the precise form disclosed.

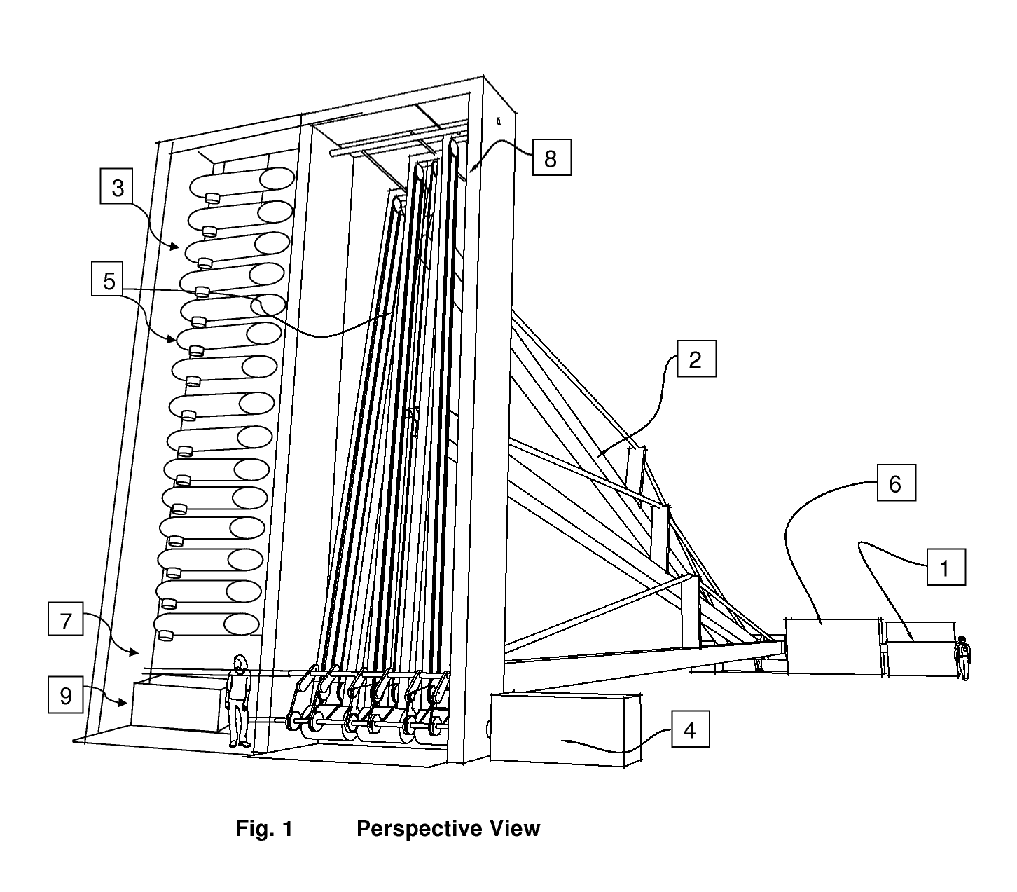

Referring to the drawings, the gravity system of the present invention for generating electricity is illustrated. Please refer to FIG. 1. FIG. 1 is a perspective diagram showing a preferred embodiment for generating electricity by gravity and long mechanical leverage arms according to the present invention. A gravity generating system includes a system body 8, a conveyer circulating device 5, and a generator 1. The system body 8 is a frame used for supporting other parts of the system including four long mechanical leverage arms and conveyer cylinder tanks. The working medium is stored in the lower tank 9 and pumped directly to the first top conveyer cylinder tank. As all the said conveyer cylinder tanks 3 are filled going down the working medium continually fills to the first empty conveyer cylinder tank as it comes up and change direction, downwardly of which the said conveyer cylinders tank are substantially vertically spacedly mounted on the circulating device 5 and moved vertically due to the impulse as a result of receiving the working medium. The circulating device 5 circulates on the system body 8 continuously corresponding to the downward motion as gravity force, and drives the working shaft of 4 motor to be rotated thus the said motor 4 requiring minimum turning torque. The generator 1 then converts the kinetic energy to electric energy. The falling working medium is pumped into the upper conveyer cylinder tank 3 for continuous operation. The theory of this system in FIG. 1 is to transform potential energy of working medium to electrical energy along with the long mechanical leverage arms.

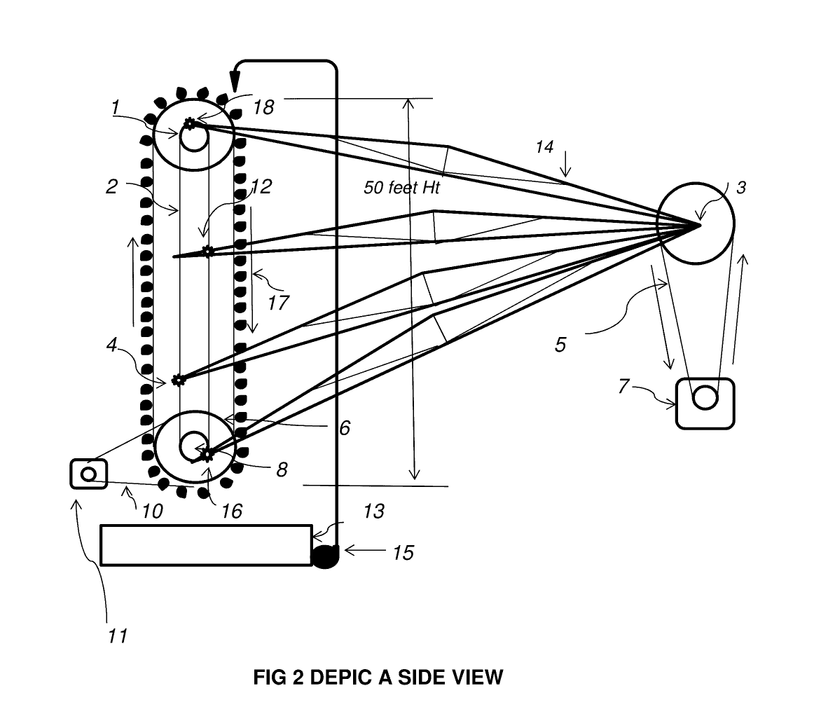

Referring to the drawing in FIG. 2, discloses use of long mechanical leverage arms and gravity to generate electricity in this device wherein an example of with exact calculation and breakdown is illustrated of operating a 60 Kw generator 7 with aid of said device. The said 60 Kw generator 7 is connected to a output shaft of primary transmission 5 of a ratio of 1;1500, the said transmission 5 input shaft has four of the second end of the long mechanical leverage arms connected with one way clutch assemblies' 3 of which many types of one way clutch assemblies can be used, such as ratchet type one way clutch, a sheet metal lifting clamp type of a one way clutch, a bearing type one way clutch, heavy duty trucks clutch and pressure plate assemblies used with a aid of a computer to operate a screw drive to release and engage as a one way clutch, a disc rotor and caliper type to stop the rotor and release, operated by computer as one way clutch with some modifications, thus rotating the primary transmission 5 input shaft in one direction as the four 100 feet long mechanical leverage arms 14 reciprocates with aid of a separate first vertical conveyer 2 that has 50 feet height on 6 inch diameter sprocket gears 8, 1 and chains lubricated in a oil bath, each first end of long mechanical leverage arm 14 is independently fixed to separate sprocket chain 12, 4, 16, 18 on sliding bearings at a specific fixed location on each of the individual sprocket chain, as the sprocket gears 8, 1 are rotated on a common shaft, the said sprocket chains exerts force on the each first end of long mechanical leverage arm 14 thus a reciprocation motion plays a vital role applying a positive turn on the primary transmission 5 input shaft whereby the one way clutches 3 on the second end of the said four long mechanical leverage arms 14. The said electrical motor of 2 hp, 3000 rpm 3.5 lbft of torque 4 in Diameter 11 is connected to a secondary transmission 10 with a ratio of 1:7.5 turning a v-belt or sprocket chain gear of 30 inch Diameter 6 on a common shaft of the 6 inch sprocket gear 8. A larger diameter conveyer ends are placed on the common 8, 1 shafts that conveys the conveyer cylinders tanks 17 from top to bottom filled with working medium to apply gravity force as the emptied conveyer cylinder tanks 17 rises on the said conveyer to the top are filled with the working material from the first tank 13 by the pump 15 that has is a 10 hp pump consuming 6 Kw power 50 ft head height, pumping 500 gal of water a minute that equites to 4170 lbs water weight therefore all of 500 gallons in the conveyer cylinder tanks 17 when filled from the top going down of the said conveyer system to the bottom equals to 4170 lb of force continuously as each of the conveyer cylinder tanks 17 at the top get filled repeatedly and the same time each of the bottom conveyer cylinder tanks gets emptied repeatedly, thus gravity force of 4170 lbs is applied to each of the first end of the long mechanical leverage arms 14 consistently as the each said long mechanical leverage arms 14 repeatedly applies force, this force is multiplied by 100 ft applying a torque of 417,000 lbft torque with the aid of one way clutches 3 furthermore the said electrical 2 hp motor 11 applies addition torque of 3.5 lbft multiplied by 7.5 secondary transmission ratio equals 26.25 lbft multiplied by 5 (the difference between 6 in sprocket gear 8, 1 and 30 in v-belt or sprocket gear 6) equals 131 lbft plus 4170 lb of water weight equal 4301 lbs. that would produce 430,100 lbft force on the primary transmission 5. The said generator 7 in this example is a 60 Kw equals 281.71 lbft torque at 1500 rpm therefore the total torque required at the primary transmission 5 input shaft equals to 422,557.75 lbft divide by 100 ft equals 4225.75 minus 4301.00 lbft produced by the conveyer system equals to 75.7 lbft positive transferred to the said generator at full load.

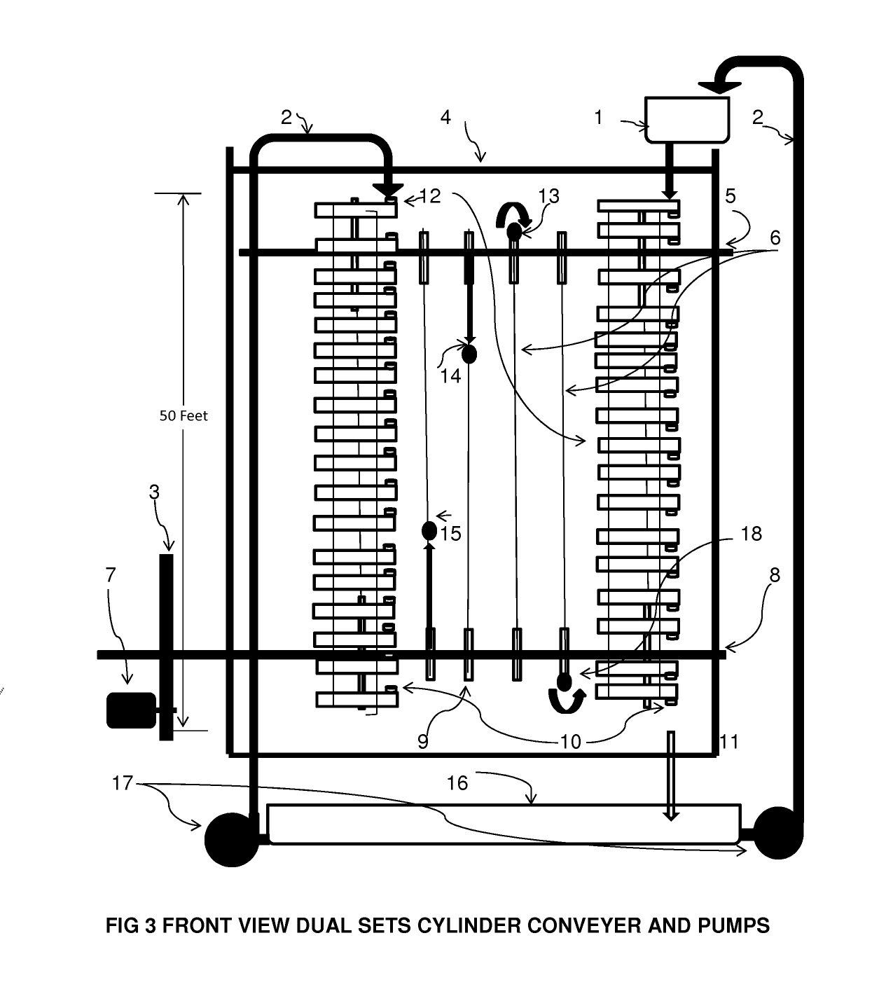

Referring to the drawing in FIG. 3 depict a front view of the two sets of conveyers 4 combine to operate as a single uniform system, first set operates the long mechanical arms conveyer 13, 14, 15, and 18. and the second is conveys conveying cylinder tanks 12 applying gravity force downwardly, upon the second sets of said conveyer cylinder 12 reaching the bottom discharging working material into the first tank 16 furthermore the said conveyer cylinders turns around and returns to be filled with working material repeatedly with the aid of the pump 17 to pump the working material through a large pipe 2 directly into the conveyance cylinder 12 on the left or the second tank 1 on the right as the said two sets conveyer circulates uniformly the said first set, conveys the long mechanical arms 13, 14 15 and 18 functions in a synchronized manner, as the long mechanical arm 14 is going down from precisely quarter way down so is the long mechanical arm 15 going up equally a quarter way up thus the weight of the said long mechanical arms 14, 15 are equally balanced to on each other as a set, so is the long mechanical arms 13, 18 equally balanced on each other as a set. All four of the said long mechanical arms are equally spaced to function and maintain a continuous reciprocation action and a positive turn on the primary transmission input shaft though the use of one way clutches whereby turning the generator. It is understood that second conveyer conveying cylinders can be on the right or the left as one and function to apply gravity force. The motor 7 maintain 3000 rpm turning the secondary gearbox 3 output shaft 8 whereby maintain a constant speed at the said shaft 8 and 5

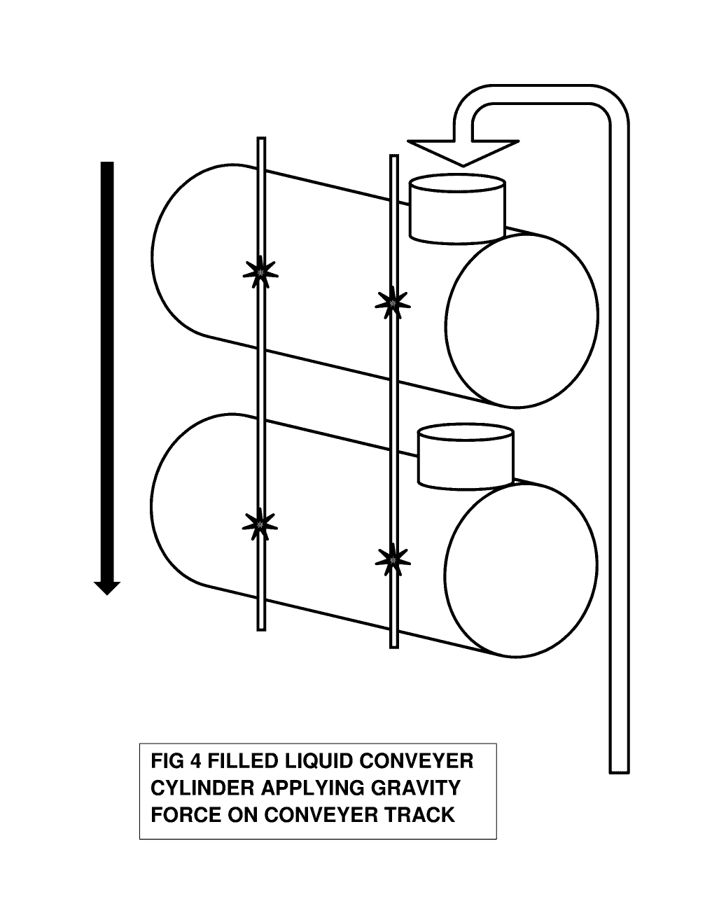

Referring to the drawing in FIG. 4 depict working material filled said conveyer cylinder tanks applying gravity force attached to the circulating conveyer many different shapes and sizes can be attached to operate the said device.

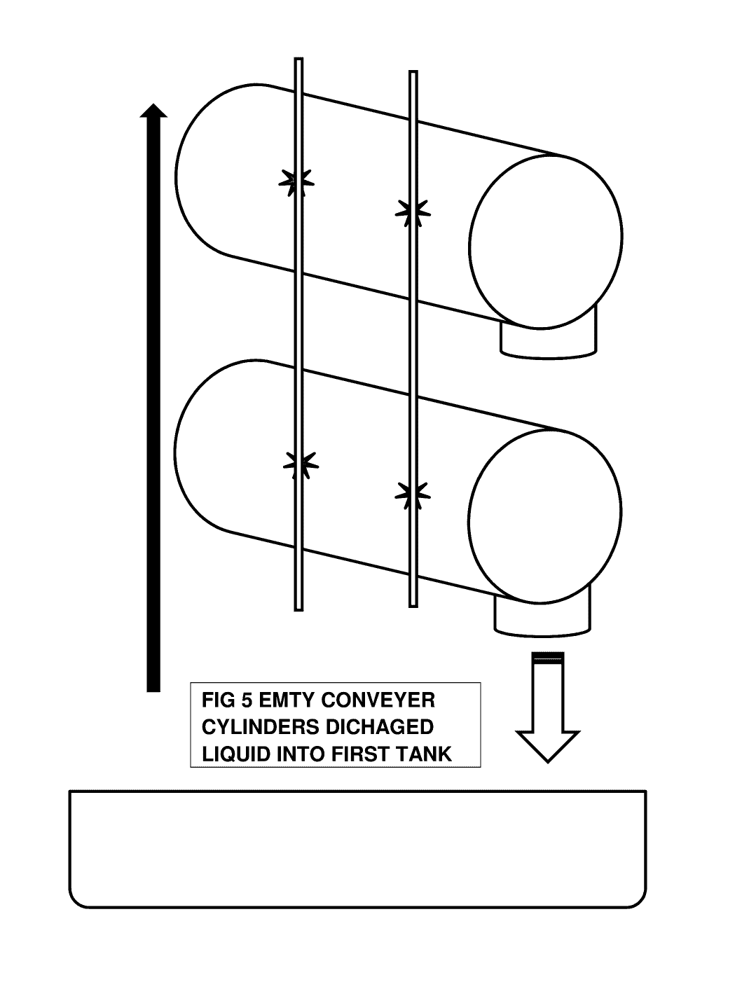

Referring to the drawing in FIG. 5 depict working material discharged from the conveyer cylinder tanks, in an upwards motion, of the said circulating conveyer

Referring to the drawing in FIG. 6 depict multiple unit combined as a farm of power units wherein the generator 2 of 240 Kw is driven by the primary transmission 6 combined side by side where the reciprocating long leverage arms 1 that are 100 ft length on both sides of the said combined primary transmission 6 are reciprocated by the vertical conveyers at both end of the device on which the conveyer cylinder tanks circulates as they are filled by the pumps 4 with the working material that's driven by the gravity force.

It is understood that the foregoing description provides an example of the embodiments contemplated herein and those skilled in the art will grasp modification, derivations and improvements without departing from the principals of the present invention. The claims should therefore not be limited thereto but be afforded the scope of such modification, derivation and improvements.

What is claimed is:

1. A system for generating electricity by gravity and long mechanical leverage arms comprising;
a system body attached to the said long mechanical leverage arms reciprocating;
a circulating device circulatably mounted on said system for circulating the conveyer mounted cylinder tanks along with the said reciprocating long mechanical leverage arms reciprocating on the said system body;
a motor attached to secondary transmission operating the system body to regulate rpm at the generator end;
a second storage tank mounted at the top of said system body loading fluid as working medium;
a large pipe alternatively supplying the said working medium from the first lower tank;
a generator having a working shaft driven by the primary transmission;
a plurality of said conveyer mounted cylinder tanks vertically spacedly mounted on said conveyer circulating device for receiving said working medium from said second upper storage tank or a large pipe pumping from the first lower storage tank of the said device, thereby driving said conveyer circulating device to be rotated along said circulating device to apply gravity force to the said long mechanical leverage arms;
a guiding device secured vertically to said system body for guiding said circulating device to circulate along said guiding device and reciprocate said long mechanical leverage arms;
a secondary transmission mounted between said circulating device and said electrical motor for maintaining a rotational speed of said working shaft of said generator as specified.

2. A system for generating electricity according to claim 1, wherein four of the said long mechanical leverage arms reciprocating as two sets of turning force timed in sequence to maintain a continuous torque to the primary transmission.

3. A system for generating electricity according to claim 1, wherein the first end of each of the said four long mechanical leverage arms reciprocating is attached to the said vertical conveyer circulating device and the other second end of each said long mechanical leverage arm is fixed to a one way clutch assembly to turn the primary transmission input shaft.

4. A system for generating electricity according to claim 1, wherein, a top second tank receives or a large pipe to deliver said working medium from said lower first tank with aid of a pump so that said circulating device along with the conveyer cylinder tanks is continuously driven to be rotated.

5. A system for generating electricity according to claim 4, wherein said second tank further includes;
a basic outlet for supplying therefrom a fixed amount of said working medium to said first said conveyer mounted cylinder tank;
an adjustable outlet for supplying therefrom metered amount of said working medium to said conveyer mounted cylinder tank; and an overflow outlet for overflowing therefrom said working medium contained therein.

6. A system for generating electricity according to claim 1 wherein said momentum stabilizing device is a fly wheel attached to said secondary transmission, further comprising a braking device mounted on the flywheel.

7. A system for generating electricity according to claim 1 wherein said primary transmission input shaft is connected to the said four one way clutches on the second end of the long mechanical leverage arms, and the output shaft of the said primary transmission shaft connected to the said generator.

8. A system for generating electricity according to claim 1 wherein the said primary transmission and the secondary transmission are equipped with a flywheel, a momentum stabilizing device to maintain the required rpm at the generator end.

9. A system for generating electricity according to claim 1, further comprising;
a first lower tank for collecting therein said working medium obtained from said second conveyer mounted cylinder tanks as they dumping; and a pumping device for pumping said working medium from said first lower tank to said second upper tank or through a large pipe.

10. A system for generating electricity according to claim 1 wherein the said first lower tank can be replaced by using a swimming pool as the said first lower tank whereby a common pump can be used both to transport the said working medium to top second tank to operate the said device and to clean and filter the swimming pool water.

11. A system for generating electricity according to claim 1 wherein said circulating device includes;
a plurality of parallelly spaced ladder shafts circulatably mounted on said system body;
a plurality of connecting pieces respectively connecting together said rotary ladder shafts;
a plurality of fixing pieces respectively fixed to said rotary ladder shafts for respectively fixing thereto said conveyer mounted cylinder tanks;
a guiding device secured to said system body for guiding said rotary ladder shafts to circulate along said system body and to reciprocate the said first end of the long mechanical leverage arms systematically.

12. A system for generating electricity according to claim 1 wherein each of said conveyer mounted cylinder tanks includes:
a opening for guiding said working medium to downwardly flow of said conveyer mounted cylinder tanks upon reaching the bottom, from each of the said conveyer cylinder tank respectively dump as they turn downwardly to an adjacent said first storage tank below.

13. A system for generating electricity according to claim 12 wherein said each conveyer mounted cylinder tank uses the same said opening as inlet and once turned a bottom outlet thus communicating there between said opening and the first lower tank.

14. A system for generating electricity according to claim 1 wherein a plurality of the said device is combined as a farm of power units.
